(19) United States
(12) Patent Application Publication
(10) Pub. No.: US 2023/0417005 A1
(43) Pub. Date: Dec. 28, 2023

(54) Portable Beach Wall Device

(71) Applicant: Branden Ellenberger, Warrington, PA (US)

(72) Inventor: Branden Ellenberger, Warrington, PA (US)

(21) Appl. No.: 18/337,466

(22) Filed: Jun. 20, 2023

Related U.S. Application Data
(60) Provisional application No. 63/356,206, filed on Jun. 28, 2022.

(51) Int. Cl. E02B 3/10; F16M 13/02; H01M 10/46

(52) U.S. Cl. CPC E02B 3/106; F16M 13/02; H01M 10/46

(57) ABSTRACT

The present invention relates to a portable beach wall device that can be used to prevent tides from splashing an area where a user is sitting at on the beach throughout the day. The device is primarily comprised of a body with a generally pointed second end and a pair of fasteners on each edge that allow the device to attach to another device. A plurality of the devices can be driven into a ground surface of a beach and attached to one another via the fasteners on each edge to form a customizable barrier between a user and a body of water.

### CROSS-REFERENCE TO RELATED APPLICATION

The present application claims priority to, and the benefit of, U.S. Provisional Application No. 63/356,206, which was filed on Jun. 28, 2022, and is incorporated herein by reference in its entirety.

### FIELD OF THE INVENTION

The present invention relates generally to the field of barriers and temporary walls. More specifically, the present invention relates to a portable beach wall device primarily comprised of a body with a generally pointed second end and a pair of fasteners on each edge that allows the device to attach to another device. A plurality of the devices can be driven into a ground surface of a beach and attached to one another via the fasteners on each edge to form a customizable barrier between a user and a body of water to prevent tides from splashing the area where the user is sitting on the beach. In addition, the devices can be removed from one another and easily transported after being used. Accordingly, the present disclosure makes specific reference thereto. Nonetheless, it is to be appreciated that aspects of the present invention are also equally applicable to other like applications, devices, and methods of manufacture.

### BACKGROUND

While enjoying time at the beach, beachgoers will inevitably be forced to move their position and belongings on the beach due to changing tides. If beachgoers do not move quickly enough to avoid an incoming tide, personal belongings may be washed away into the body of water due to the rising tide. Constantly packing up and moving to different positions along the beach at different times of the day can be frustrating and annoying for beachgoers.

Therefore, there exists a long-felt need in the art for a device that can be used to avoid tides while on a beach. More specifically, there exists a long-felt need in the art for a portable beach wall device that can be erected on a beach between a user and a body of water to prevent the tide from encroaching on the area the user is sitting on the beach. There also exists a long-felt need in the art for a portable beach wall device that allows a user to create any length and arrangement of barrier desired to prevent the tide from encroaching on the area the user is sitting on the beach.

The subject matter disclosed and claimed herein, in one embodiment thereof, comprises a portable beach wall device. The device is primarily comprised of a body with a generally pointed second end and a pair of fasteners on each edge that allow the device to attach to another device. A plurality of the devices can be driven into a ground surface of a beach and attached to one another via the fasteners on each edge. As a result, the devices can form a customizable barrier between a user and a body of water to prevent tides from splashing the area where the user is sitting on the beach. In addition, the devices can be removed from one another and easily transported after being used. The device may also be comprised of a plurality of other advantageous features such as, but not limited to, an umbrella holder, a portable battery charged by a solar panel, and a hook.

In this manner, the portable beach wall device of the present invention accomplishes all of the foregoing objectives and provides a device that can be used to avoid tides while on a beach. During use, the device can be erected on a beach between a user and a body of water to prevent the tide from encroaching on the area where the user is sitting on the beach. The device can be attached to another device, such that the devices allow a user to create any length and arrangement of barrier desired to prevent the tide from encroaching on the area where the user is sitting on the beach. Therefore, a user can remain at one position on a beach throughout an entire day, irrespective of current tides.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable beach wall device primarily comprised of a body with a generally pointed second end and a pair of fasteners on each edge that allows the device to attach to another device. The body preferably has a flat first end and a generally pointed second end that can penetrate a ground surface such as, but not limited to, sand. In one embodiment, the body may be hollow such that it can be filled with water or sand to increase the overturning moment force of the device when placed within a ground surface.

The left edge of the body is comprised of at least one fastener. The right edge of the body is similarly comprised of at least one fastener. Both fasteners are preferably reciprocating fasteners such that a left edge fastener of a first device can attach to a right edge fastener of a second device. In this manner, two devices can be removably attached to one another to form a barrier to prevent water from entering a desired area at a beach.

The top edge of the body is preferably comprised of a padding that prevents an individual from being cut or injured by the top edge. The top surface of the padding is preferably impact resistant such that it can be struck by a hammer, mallet, etc., to allow the second end to be driven into the ground. In one embodiment, the padding is comprised of at least one handle that allows the device to be easily positioned and pulled out of the ground as needed.

In one embodiment, the device may be comprised of numerous other features such as at least one umbrella holder and at least one hook that allows a user to hang a bag, towel, or other item. In addition, one embodiment of the device may be comprised of at least one solar panel that provides a charge to at least one battery that can be used to charge numerous devices.

The device is also comprised of a method of use. First, a second end of a first device is secured in a ground surface via striking the padding such that the device is positioned in between a body of water and a location a user is sitting on the ground surface wherein water from the body of water cannot hit the user. Then, a second device is secured in the ground surface next to the first device by striking the padding while a fastener of the first device engages a fastener of the second device. More devices can then be secured into the ground surface and attached to the existing devices via the fasteners as needed, such that a barrier is formed between the user and the body of water.

Accordingly, the portable beach wall device of the present invention is particularly advantageous as it provides a device that can be used to avoid tides while on a beach. More specifically, the device can be erected on a beach between a user and a body of water to prevent the tide from encroaching on the area the user is sitting on the beach. While doing so, a plurality of the devices can be attached to one another to form any length and arrangement of barrier desired. In this manner, the portable beach wall device provides a novel solution to avoid tides while enjoying a beach.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable beach wall device of the present invention in accordance with the disclosed architecture;

FIG. 2 illustrates a perspective view of a plurality of one potential embodiment of a portable beach wall device of the present invention while attached to one another and secured in a ground surface in accordance with the disclosed architecture;

FIG. 3 illustrates a perspective view of a plurality of one potential embodiment of a portable beach wall device of the present invention while attached to one another and secured in a ground surface in accordance with the disclosed architecture; and

FIG. 4 illustrates a flowchart of a method of using one potential embodiment of a portable beach wall device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to avoid tides while on a beach. More specifically, there exists a long-felt need in the art for a portable beach wall device that can be erected on a beach between a user and a body of water to prevent the tide from encroaching on the area where the user is sitting on the beach. There also exists a long-felt need in the art for a portable beach wall device that allows a user to create any length and arrangement of barrier desired to prevent the tide from encroaching on the area where the user is sitting on the beach.

The present invention, in one exemplary embodiment, is comprised of a portable beach wall device primarily comprised of a body with a generally pointed second end and a pair of fasteners on each edge that allow the device to attach to another device. The body preferably has a flat first end and a generally pointed second end that can penetrate a ground surface such as, but not limited to, sand. In one embodiment, the body may be hollow. In this embodiment, the body can be filled with water to increase the overturning moment force of the device when placed into a ground surface.

The left edge and the right edge of the body are each comprised of at least one fastener. Both fasteners are preferably reciprocating fasteners such that a left edge fastener of a first device can attach to a right edge fastener of a second device. In this manner, two devices can be removably attached to one another to form a barrier to prevent water from hitting a desired area at a beach.

The top edge of the body is preferably comprised of a padding. The padding prevents an individual from being cut or injured by the top edge. The top surface of the padding is preferably impact resistant such that it can be struck by a hammer, mallet, etc., to allow the second end to be driven into the ground. In one embodiment, the padding is comprised of at least one handle that allows the device to be easily positioned and pulled out of the ground as needed.

The device may also be comprised of numerous other features, such as at least one umbrella holder and at least one hook that allows a user to hang a bag, towel, or other item. In addition, one embodiment of the device may be comprised of at least one solar panel that provides a charge to at least one battery that can be used to charge numerous devices.

In addition, the device is comprised of a method of use. First, a second end of a first device is secured in a ground surface via striking the padding such that the device is positioned in between a body of water and a location where a user is sitting on the ground surface, wherein water from the body of water cannot hit the user. Then, a second device is secured in the ground surface next to the first device by striking the padding. A fastener of the first device engages a fastener of the second device to secure both devices to each other. More devices can then be secured into the ground surface and attached to the existing devices via the fasteners as needed, such that a barrier is formed between the user and the body of water.

Accordingly, the portable beach wall device of the present invention is particularly advantageous as it provides a device that can be used to avoid tides while on a beach. More specifically, the device can be erected on a beach between a user and a body of water to prevent the tide from encroaching on the area where the user is sitting on the beach. While doing so, a plurality of the devices can be attached to one another to form any length and arrangement of barrier desired. In this manner, the portable beach wall device provides a novel solution to avoid tides while enjoying a beach.

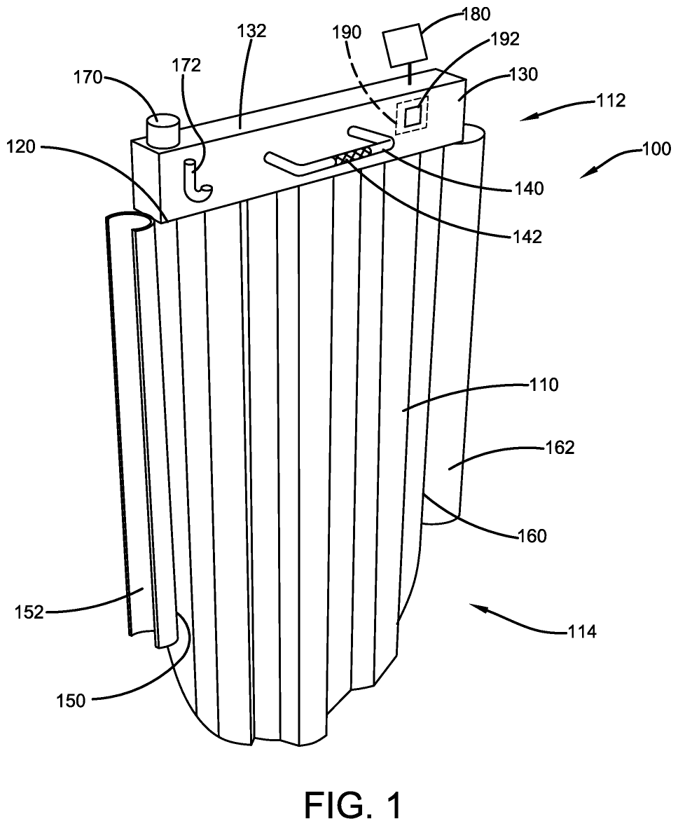

Referring initially to the drawings, FIG. 1 illustrates a perspective view of one potential embodiment of a portable beach wall device 100 of the present invention in accordance with the disclosed architecture. The device 100 is primarily comprised of a body 110 with a generally pointed second end 114 and a pair of fasteners 152,162 on each edge 150,160 that allow the device 100 to attach to another device 100. The body 110 preferably has a flat first end 122 and a generally pointed second end 114. The second end 114 may be pointed or may be a rounded point in differing embodiments such that it can penetrate a ground surface 10 such as, but not limited to, sand. The body 110 may be made from a durable, corrosion-resistant, metal material such as, but not limited to, aluminum. The body 110 may also be made from a rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In one embodiment, the body 110 is flat. In another embodiment, the body 110 is convex in shape to disperse waves hitting the body 110. In an additional embodiment, the body 110 may be corrugated for increased strength. In a further embodiment, the body 110 may be hollow such that it can be filled with water to increase the overturning moment force of the device 100 when placed within a ground surface 10. In this embodiment, the body 110 has at least one cap 116 of any cap-type known in the art that allows access to the interior of the body 110 for filling. The device 100 may be any height and size known in the art in differing embodiments.

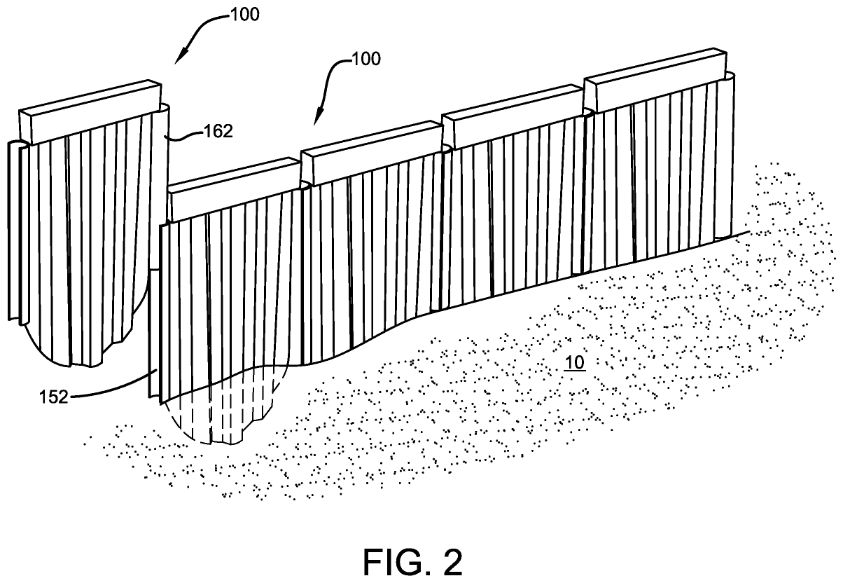

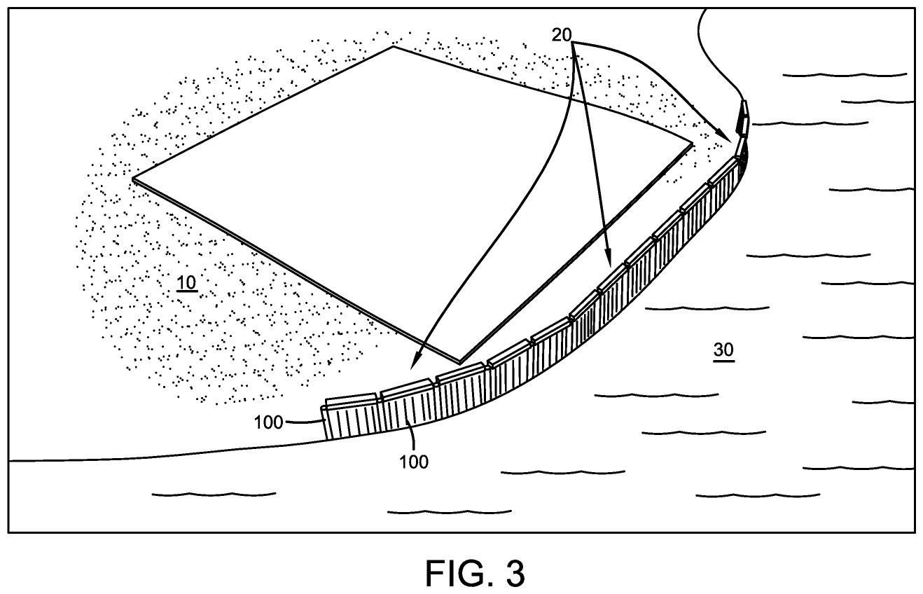

The left edge 150 of the body 110 is comprised of at least one fastener 152. The right edge 160 of the body 110 is similarly comprised of at least one fastener 162. The fasteners 152, 162 are preferably reciprocating fasteners. The left edge fastener 152 of a first device 100 is attached to a right edge fastener 162 of a second device 100. In this manner, two devices 100 can be removably attached to one another, as seen in FIG. 2. This allows a plurality of devices 100 to be used as a barrier to prevent water from hitting a desired area at a beach, as seen in FIG. 3.

The fasteners 152,162 may be any male/female and/or reciprocating fasteners known in the art such as, but not limited to, tongue and groove, magnets, bolt and bolt hole, hook and loop, etc. In the preferred embodiment, the right-side fastener 162 is comprised of a male cylindrical fastener that is inserted into a generally cylindrical or u-shaped female fastener 152 of the left edge 150.

The top edge 120 of the first end 112 of the body 110 is preferably comprised of a padding 130. The padding 130 prevents an individual from being cut or injured by the top edge 120. The top surface 132 of the padding 130 is preferably impact resistant such that it can be struck by a hammer, mallet, etc., to allow the second end 114 to be driven into the ground 10. The padding 130 may be comprised of any padding material known in the art such as, but not limited to, a charcoal foam, a closed cell foam, a dry fast foam, a high-density foam, a high-resilience foam, a latex foam, a lux foam, a memory foam, a polyurethane foam, a rebond foam, a waterproof foam, etc.

In one embodiment, the padding 130 is comprised of at least one handle 140. The handle 140 allows the device 100 to be easily positioned and pulled out of the ground 10 as needed. The handle 140 may be present on any portion of the device 100. The handle 140 may be comprised of at least one grip area 142. The grip area 142 may be comprised of a raised, recessed, or flat texturing to improve a user's grip on the handle 140. The grip area 142 is preferably made from a non-slip material. Said non-slip material includes, but is not limited to, silicone, latex, neoprene, EPDM, PVC foam, polyethylene, sponge rubber, silicone foam, urethane, cork, ridged and/or recessed rubber, felt, acrylic, polyester & SBR, etc.

In one embodiment, the device 100 may be comprised of numerous other features. One feature includes at least one umbrella holder 190 of any type known in the art that allows a user to use the device 100 as an umbrella base. Another feature is at least one fastener 172 that allows a user to hang or secure a bag, towel, or other item to the device. The fastener 172 may be a cupholder, phone holder, or any fastener that allows an item to be retained on the device 100. In addition, one embodiment of the device 100 may be comprised of at least one solar panel 180 that provides a charge to at least one battery 190. The solar panel 180 may be comprised of monocrystalline silicon, polycrystalline silicon, a photovoltaic cell film, etc.

The battery 190 may be a disposable battery 190 or a rechargeable battery 190 in the form of an alkaline, nickel-cadmium, nickel-metal hydride battery 190, etc., such as any 3V-12 volts DC battery 190 or other conventional battery 190 such as A, AA, AAA, etc., that supplies power to the device 100. Throughout this specification the terms “battery” and “batteries” may be used interchangeably to refer to one or more wet or dry cells or batteries 190 of cells in which chemical energy is converted into electricity and used as a source of DC power. References to recharging or replacing batteries 190 may refer to recharging or replacing individual cells, individual batteries 190 of cells, or a package of multiple battery cells as is appropriate for any given battery 190 technology that may be used. Additionally, the battery 190 may be recharged by at least one charging port 192. The charging port 192 may be any type known in the art such as, but not limited to, USB, 9V, 12V, 110V, 240V, etc. The charging port 192 may also allow a user to plug in any charging cord known in the art to allow a user to charge a smart device or other object from the battery 190.

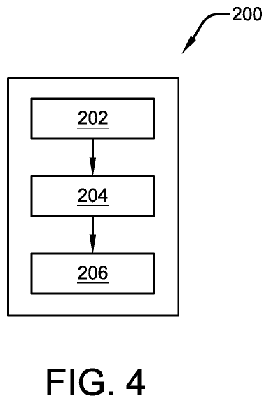

FIG. 4 illustrates a flowchart of a method of using 200 one potential embodiment of a portable beach wall device 100 of the present invention in accordance with the disclosed architecture. The device 100 is also comprised of a method of use 200. First, a second end 114 of a first device 100 is secured in a ground surface 110 via striking the padding 130 [Step 202]. It should be appreciated that the device 100 can be positioned in between a body of water 30 and a location where a user is sitting on the ground surface 10 (i.e., the beach) such that water from the body of water cannot hit the user. Then, a second device 100 is secured in the ground surface 110 next to the first device via striking the padding 130 while the fastener 152 or 162 of the first device 100 engages the fastener 152 or 162 of the second device 100 [Step 204]. More devices 100 can then be secured into the ground surface 10 and attached to the existing devices 100 via the fasteners 152,162 such that a barrier 20 is formed between the user and the body of water [Step 206]. The barrier may be arranged in a straight line, a curved line, or any other shape.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable beach wall device” and “device” are interchangeable and refer to the portable beach wall device 100 of the present invention.

Notwithstanding the foregoing, the portable beach wall device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable beach wall device 100 as shown in the FIGS. are for illustrative purposes only, and that many other sizes and shapes of the portable beach wall device 100 are well within the scope of the present disclosure. Although the dimensions of the portable beach wall device 100 are important design parameters for user convenience, the portable beach wall device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable beach wall device comprising:
a body comprised of a pointed end;
a first fastener positioned on a left edge of the body;
a second fastener positioned on a right edge of the body; and
a padding positioned on a top edge of the body.

2. The portable beach wall device of claim 1, wherein each of the first fastener and the second fastener is comprised of a pair of reciprocating fasteners.

3. The portable beach wall device of claim 2, wherein the first fastener is comprised of a u-shaped channel.

4. The portable beach wall device of claim 2, wherein the second fastener is comprised of a cylindrical fastener.

5. A portable beach wall device comprising:
a hollow body comprised of a pointed end and a cap;
a first fastener positioned on a left edge of the body;
a second fastener positioned on a right edge of the body; and
a padding positioned on a top edge of the body.

6. The portable beach wall device of claim 5, wherein the hollow body is comprised of a corrugated material.

7. The portable beach wall device of claim 5, wherein the hollow body is comprised of a convex body shape.

8. The portable beach wall device of claim 5, wherein the pointed end is comprised of a rounded point.

9. A portable beach wall device comprising:
a hollow body comprised of a pointed end and a cap;
a first fastener positioned on a left edge of the body;
a second fastener positioned on a right edge of the body;
a padding positioned on a top edge of the body;
a handle; and
a solar panel.

10. The portable beach wall device of claim 9, wherein the first fastener is comprised of a tongue fastener, a groove fastener, a magnet, a bolt, a bolt hole, a hook fastener or a loop fastener.

11. The portable beach wall device of claim 9, wherein the second fastener is comprised of a tongue fastener, a groove fastener, a magnet, a bolt, a bolt hole, a hook fastener or a loop fastener.

12. The portable beach wall device of claim 9, wherein the padding is comprised of a charcoal foam, a closed cell foam, a dry fast foam, a high-density foam, a high-resilience foam, a latex foam, a lux foam, a memory foam, a polyurethane foam, a rebond foam, or a waterproof foam.

13. The portable beach wall device of claim 9, wherein the padding is comprised of an impact resistant top surface.

14. The portable beach wall device of claim 9, wherein the handle is comprised of a grip area.

15. The portable beach wall device of claim 14, wherein the grip area is comprised of a raised, a recessed or a flat texture.

16. The portable beach wall device of claim 14, wherein the grip area is comprised of a non-slip material.

17. The portable beach wall device of claim 9 further comprised of an umbrella holder.

18. The portable beach wall device of claim 9 further comprised of a hook.

19. The portable beach wall device of claim 9 further comprised of a battery charged by the solar panel.

20. The portable beach wall device of claim 19, wherein the battery is comprised of a charging port.
